(19) United States
(12) Patent Application Publication
(10) Pub. No.: US 2025/0238808 A1
(43) Pub. Date: Jul. 24, 2025

(54) MANAGING COMPLIANCE WITH COURIER SERVICE REQUIREMENTS

(71) Applicant: Fovea2 LLC, San Francisco, CA (US)

(72) Inventors: Gregory George Jagiello, Tucson, AZ (US); Tyler Miller, Phoenix, AZ (US); Sarah Duryea, Boca Raton, FL (US); Daren Henderson, Westwood, CA (US); Kyle Roehrs, Walnut Creek, CA (US); Issac Jacob Roth, San Francisco, CA (US)

(21) Appl. No.: 18/589,275

(22) Filed: Feb. 27, 2024

Related U.S. Application Data
(60) Provisional application No. 63/622,857, filed on Jan. 19, 2024.

(51) Int. Cl. G06Q 30/018

(52) U.S. Cl. CPC G06Q 30/018

(57) ABSTRACT

A facility for managing compliance with courier service requirements is described. The facility receives courier service requirements for an order including preliminary requirements and a sequence of courier service steps. The facility provides the preliminary requirements to a device of a courier agent. Then, the facility displays a visual interface including an indication of the courier agent. In response to receiving preliminary compliance evidence, the facility adds an indication of compliance to the displayed interface. In response to receiving a selection by a customer of the courier agent using the interface, the facility causes the sequence of courier service steps to be sequentially displayed using the device of the courier agent. In response to receiving execution compliance evidence, the facility creates an indication of compliance for the order reflecting the preliminary compliance evidence and the execution compliance evidence. The facility makes the indication of compliance accessible to the customer.

### CROSS-REFERENCE TO RELATED APPLICATIONS

This application claims the benefit of provisional U.S. App. No. 63/622,857, filed Jan. 19, 2024, and entitled “MANAGING COMPLIANCE WITH COURIER SERVICE REQUIREMENTS” which is hereby incorporated by reference in its entirety.

This application is related to U.S. application Ser. No. 17/349,561, filed Jun. 16, 2021, and entitled “DISCHARGING COURIER SERVICE ASSIGNMENTS” which is hereby incorporated by reference in its entirety.

This application is related to U.S. application Ser. No. 17/349,565, filed Jun. 16, 2021, and entitled “DISCHARGING COURIER SERVICE ASSIGNMENTS” which is hereby incorporated by reference in its entirety.

This application is related to U.S. application Ser. No. 17/833,669, filed Jun. 6, 2022, and entitled “DISCHARGING COURIER SERVICE ASSIGNMENTS” which is hereby incorporated by reference in its entirety.

This application is related to U.S. application Ser. No. 18/505,060, filed Nov. 8, 2023, and entitled “DISCHARGING COURIER SERVICE ASSIGNMENTS” which is hereby incorporated by reference in its entirety.

In cases where the present application conflicts with a document incorporated by reference, the present application controls.

### BACKGROUND

Courier services transport physical objects, picking them up at an originating location and delivering them to a destination location. Many courier service assignments involve particular processes or other requirements. These can relate to how to enter or depart the originating and destination locations, how to retrieve or deliver the object, how to handle the object, or qualifications of a courier agent necessary to perform the assignment, for example.

### BRIEF DESCRIPTION OF THE DRAWINGS

FIG. 1 is a network diagram showing an environment in which the facility operates.

FIG. 2 is a flow diagram showing a process used by the facility in some embodiments to manage compliance with courier service requirements.

FIG. 3 is a display diagram illustrating an interface used by the facility in some embodiments to manage preliminary compliance requirements available for inclusion in a protocol.

FIG. 4 is a display diagram illustrating an interface used by the facility in some embodiments to attach a preliminary compliance requirement to a protocol.

FIGS. 5A, 5B, and 5C are display diagrams illustrating various interfaces used by the facility in some embodiments to display preliminary compliance requirements to a courier agent.

FIG. 6 is a display diagram illustrating an interface used by the facility in some embodiments to display a plurality of courier agent contracting entities.

FIG. 7 is a display diagram illustrating an interface used by the facility in some embodiments to manage preliminary compliance requirements for a courier agent associated with a courier agent contracting entity.

FIG. 8 is a display diagram illustrating an interface used by the facility in some embodiments to display hierarchical compliance information for a courier service order.

FIG. 9 is a flow diagram showing a process used by the facility in some embodiments to manage compliance with courier service requirements by a device of a courier agent.

FIGS. 10A, 10B, and 10C are display diagrams illustrating various interfaces used by the facility in some embodiments to enable permission-restricted access to sensitive information relating to a courier service order.

FIG. 11 is a display diagram illustrating an interface used by the facility in some embodiments to display a sensitive data access report for a courier service order.

### DETAILED DESCRIPTION

The inventors have recognized significant disadvantages of conventional approaches to verifying compliance of logistics service providers (LSPs) and courier agents with courier service requirements. Compliance with requirements is often recorded manually and may not be stored accessibly, making it difficult to audit compliance with courier service requirements. Furthermore, courier agents often rely on verbal or manually written instructions to understand their own compliance responsibilities, leading to requirements not being met or documented. Compliance with privacy requirements for some courier service assignments is also compromised when sensitive data related to a courier service assignment is available in situations where it is not necessary. Ensuring compliance with courier service requirements is especially critical when objects such as organs, medications, hazardous materials, or fine art are being transported. Managing compliance with these processes and other requirements is often burdensome, especially when information must be managed across multiple logistics service providers (LSPs) and numerous individual courier agents.

In response to recognizing these disadvantages, the inventors have conceived and reduced to practice a software and/or hardware facility for managing compliance with courier service requirements (“the facility”).

The facility provides a distributed application that receives from a customer courier service requirements defining courier agent assignment requirements (preliminary requirements) and a sequence of courier service steps. The facility provides the preliminary requirements to a device of a courier agent. In response to receiving preliminary compliance evidence for each of the preliminary requirements, the facility adds an indication of the courier agent to an interface accessible to the customer. In response to receiving a selection of the courier agent from the customer, the facility causes the sequence of courier service steps to be sequentially displayed on a device of the courier agent. In response to receiving execution compliance evidence for each step in the sequence of steps, the facility creates an indication of compliance based on the preliminary compliance evidence and the execution compliance evidence. The facility then makes the indication of compliance available to the customer and/or other involved parties.

By performing in some or all of the ways described above, the facility manages compliance with courier service requirements. Also, the facility improves the functioning of computer or other hardware, such as by reducing the dynamic display area, processing, storage, and/or data transmission resources needed to perform a certain task, thereby enabling the task to be permitted by less capable, capacious, and/or expensive hardware devices, and/or be performed with lesser latency, and/or preserving more of the conserved resources for use in performing other tasks. For example, by providing an indication of compliance with courier service requirements, the facility conserves additional storage and processing resources that would be required for the customer to individually audit each requirement in the courier service requirements.

Further, for at least some of the domains and scenarios discussed herein, the processes described herein as being performed automatically by a computing system cannot practically be performed in the human mind, for reasons that include that the starting data, intermediate state(s), and ending data are too voluminous and/or poorly organized for human access and processing, and/or are a form not perceivable and/or expressible by the human mind; the involved data manipulation operations and/or subprocesses are too complex, and/or too different from typical human mental operations; required response times are too short to be satisfied by human performance; etc. For example, a human mind cannot require a device requesting access to sensitive information to be within a geofenced area to access the sensitive information

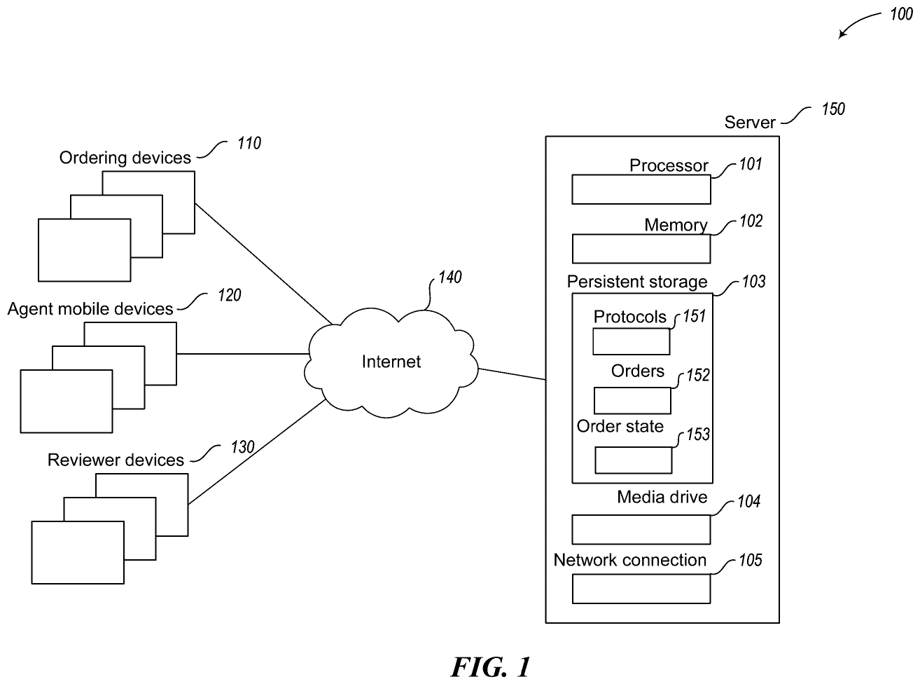

FIG. 1 is a network diagram showing an environment 100 in which the facility operates in some embodiments. One or more servers 150 store the following: protocol definitions 151 that, for each of a number of protocols, specify a set of steps making up the protocol; these protocol definitions may be created by customers, members of the courier organization, people involved in the operation of a facility, etc.; one or more courier orders 152, each specifying such information as pickup location and time, dropoff location and time, and pickup and dropoff protocols; and order state information 153 including, for each order among the orders, data about the extent to which it has been completed, compliance evidence, messages exchanged about the order, etc. The server is connected via the Internet or another network 140 to a variety of devices. Ordering devices 110 interact with the server in order to create or revise orders. These ordering devices may be used by customers or employees of the courier service using a communication modality such as voice call, video conference, text message, email message, etc. Agent mobile devices 120 include smart phones or tablets that are carried by the courier agents and receive information from the server about orders and communications that relate to them, and transmit information to the server about performance of orders and communication about them. Reviewer devices 130 are used by reviewers such as the customer, employees of the courier service, or people involved in the operation of the facility to monitor the state of future, in-process, or past orders and communicate with others such as the courier about these orders.

In various embodiments, these computer systems and other devices can include server computer systems, cloud computing platforms or virtual machines in other configurations, desktop computer systems, laptop computer systems, netbooks, mobile phones, personal digital assistants, televisions, cameras, automobile computers, electronic media players, etc. In various embodiments, the computer systems and devices include zero or more of each of the following: a processor 101 for executing computer programs and/or training or applying machine learning models, such as a CPU, GPU, TPU, NNP, FPGA, or ASIC; a computer memory 102—such as RAM, SDRAM, ROM, PROM, etc.—for storing programs and data while they are being used, including the facility and associated data, an operating system including a kernel, and device drivers; a persistent storage device 103, such as a hard drive or flash drive for persistently storing programs and data; a computer-readable media drive 104, such as a floppy, CD-ROM, or DVD drive, for reading programs and data stored on a computer-readable medium; and a network connection 105 for connecting the computer system to other computer systems to send and/or receive data, such as via the Internet 140 or another network and its networking hardware, such as switches, routers, repeaters, electrical cables and optical fibers, light emitters and receivers, radio transmitters and receivers, and the like. None of the components shown in FIG. 1 and discussed above constitutes a data signal per se. While computer systems configured as described above are typically used to support the operation of the facility, those skilled in the art will appreciate that the facility may be implemented using devices of various types and configurations, and having various components.

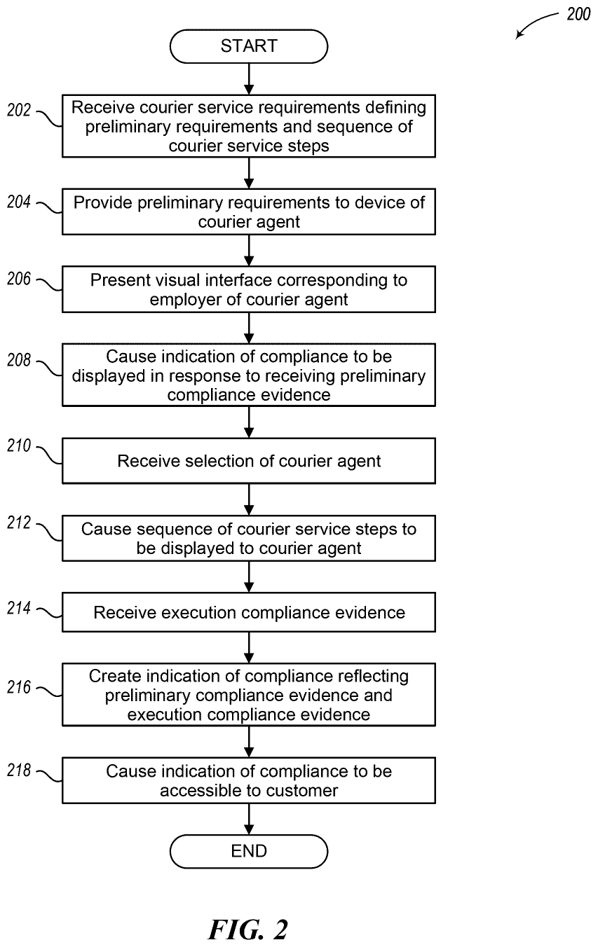

FIG. 2 is a flow diagram showing a process 200 used by the facility in some embodiments to manage compliance with courier service requirements. In various embodiments, protocols 151 in FIG. 1 include courier service requirements.

Process 200 begins, after a start block, at block 202, where the facility receives courier service requirements defining preliminary requirements and a sequence of courier service steps. A preliminary requirement defines a qualification of a courier agent required for assignment to a courier service order.

In various embodiments a preliminary requirement is a certification, a level of experience, a kind of experience, a geographic operating area, a background check, a drug screening, completion of a course, etc. For example, to complete a courier service order involving handling biohazardous materials such as blood, the courier agent in some embodiments is qualified by completion of a course, third-party certification, or experience, to handle biohazardous materials. In some embodiments, a preliminary requirement is any qualification or competence related to completing a courier service order.

The sequence of courier service steps defines one or more steps the courier agent takes to complete a courier service order. For example, in some embodiments a first step in the sequence of courier service steps includes picking up an object to be delivered, and a second step includes dropping off the object to be delivered. In some embodiments, the facility requires the courier agent to collect execution compliance evidence to complete a step. For example, the facility in various example embodiments requires the courier agent to provide a photograph of an object of the courier service order at a dropoff location, record a temperature of the object, scan a barcode coupled to the object, etc.

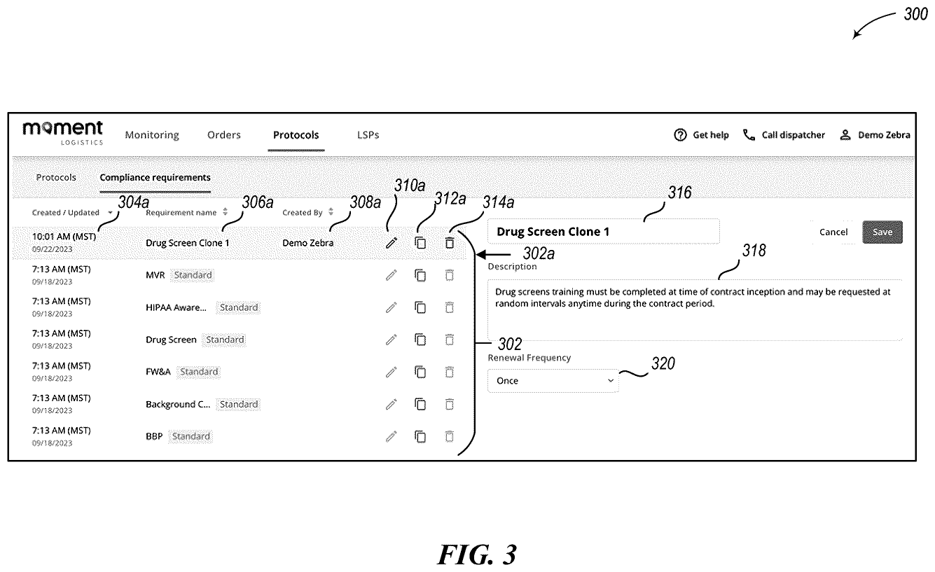

FIG. 3 is a display diagram illustrating an interface 300 used by the facility in some embodiments to manage preliminary requirements available for inclusion in a protocol.

Interface 300 includes preliminary requirements 302. Each preliminary requirement in preliminary requirements 302 is available to be used in connection with a courier service order in various embodiments. Preliminary requirements 302 includes one or more preliminary requirements, such as preliminary requirement 302a. Preliminary requirement 302a includes update time 304a, name 306a, creator name 308a, edit button 310a, copy button 312a, and discard button 314a. In the example shown in FIG. 3, preliminary requirement 302a is selected, and represents a drug screen requirement. Accordingly, information about preliminary requirement 302a is displayed in interface 300. The displayed information includes requirement name 316, description 318, and renewal frequency 320. Renewal frequency 320 refers to a frequency at which the selected preliminary requirement is to be renewed. In the example shown in FIG. 3, the renewal frequency is “Once,” indicating a periodic renewal frequency has not been established for preliminary requirement 302a. In various embodiments, renewal frequency 320 may be daily, weekly, monthly, yearly, etc.

While FIG. 3 and each of the display diagrams discussed below show a display whose formatting, organization, informational density, etc., is best suited to certain types of display devices, those skilled in the art will appreciate that actual displays presented by the facility may differ from those shown, in that they may be optimized for particular other display devices, or have shown visual elements omitted, visual elements not shown included, visual elements reorganized, reformatted, revisualized, or shown at different levels of magnification, etc.

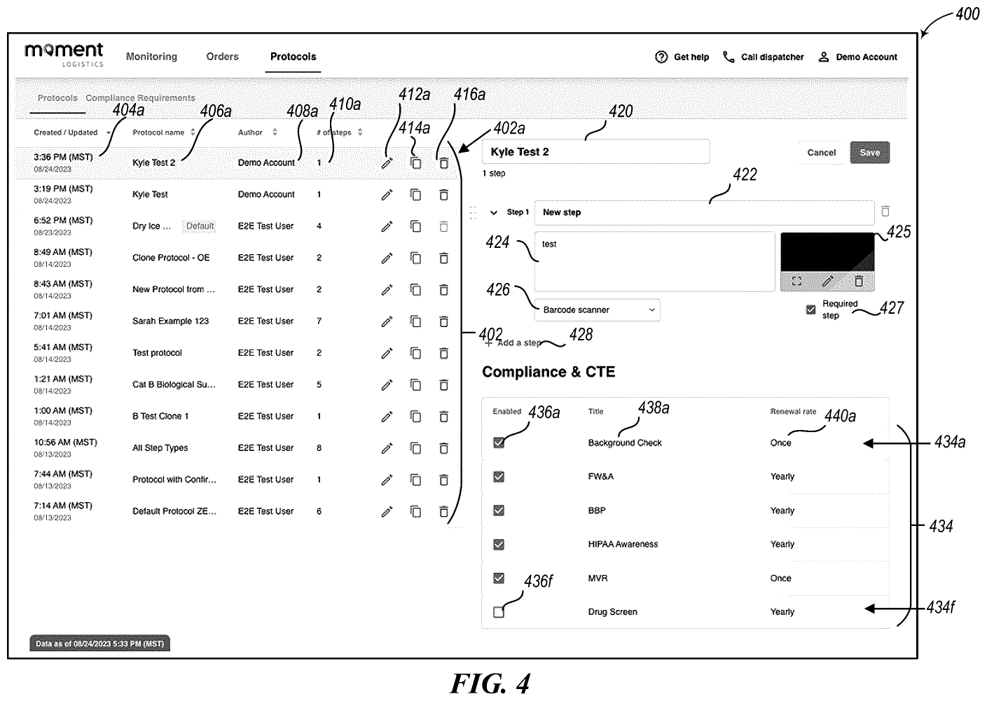

FIG. 4 is a display diagram illustrating an interface 400 used by the facility in some embodiments to attach a preliminary requirement to a protocol.

Interface 400 includes protocols 402. Each protocol in protocols 402 corresponds to a protocol that is used in connection with a courier service order in various embodiments. Protocol 402a includes an update time 404a, a protocol name 406a, an author 408a, number of steps 410a, edit button 412a, copy button 414a, and delete button 416a. In the example shown in FIG. 4, protocol 402a in protocols 402 is selected for editing using edit button 412a. Accordingly, information about protocol 402a is displayed in interface 400. The displayed information includes protocol name field 420, which allows protocol name 406a to be modified. Step name field 422 allows a step name to be modified. Step description field 424 allows a step description to be modified, while step picture field 425 allows a step picture to be modified. Compliance evidence selector 426 allows the method compliance evidence is to be collected for the step to be modified. In the example shown in FIG. 4, compliance evidence selector 426 displays “Barcode scanner,” meaning execution compliance evidence for the step is to be collected using a barcode scanner. Required step button 427 allows the step to be required or optional. In some embodiments, a required step displayed on a device of a courier agent will prevent a next step in a protocol from being displayed before the required step is completed. Add step button 428 allows a new step to be added to protocol 402a and increments number of steps 410a.

Interface 400 also displays preliminary requirements 434 for protocol 402a. Each preliminary requirement in preliminary requirements 434 corresponds to a preliminary requirement that may be used in connection with a courier service order in various embodiments. Preliminary requirement 434a includes enablement button 436a, title 438a, and renewal rate 440a. In the example shown in FIG. 4, enablement button 436a is selected, meaning preliminary requirement 434a is enabled for protocol 402a. By contrast, enablement button 436f is not selected, meaning preliminary requirement 434f is not enabled for protocol 402a.

Returning to FIG. 2, process 200 continues from block 202 to block 204, where the facility provides preliminary requirements to a device of a courier agent.

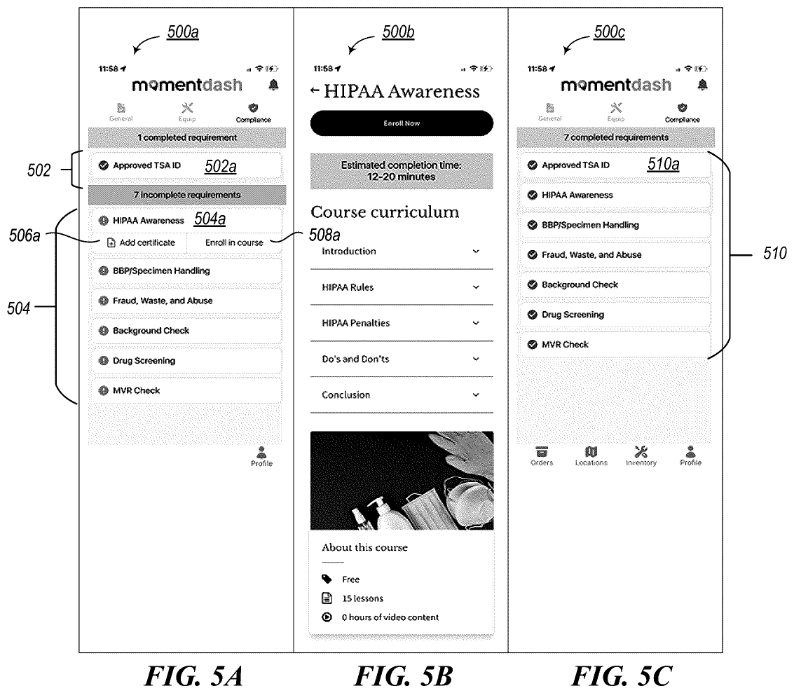

FIGS. 5A, 5B, and 5C are display diagrams illustrating various interfaces 500a, 500b, and 500c used by the facility in some embodiments to display preliminary requirements to a courier agent. In some embodiments, the facility causes interfaces 500a, 500b, or 500c to be displayed using agent mobile devices 120.

FIG. 5A illustrates an interface 500a displaying compliance requirements to a courier agent. Completed requirements 502 include completed requirement 502a. Incomplete requirements 504 include incomplete requirement 504a. Incomplete requirement 504a includes upload portal 506a and enrollment portal 508a. In some embodiments, the requirements included in incomplete requirements are determined in response to the courier agent contracting entity receiving a courier service order specifying one or more preliminary requirements the courier agent has not completed. In various embodiments, the requirements included in incomplete requirements 504 are determined based on a set of requirements to be met by all courier agents contracted by a selected courier agent contracting entity, a group of one or more courier agents to which the courier agent belongs, etc. For example, a courier agent contracting entity specializing in medical courier service orders in some embodiments requires each of their agents to complete a HIPAA Awareness requirement such as incomplete requirement 504a. In some embodiments, the facility automatically constructs incomplete requirements 504 based on a calculated demand for one or more preliminary requirements across one or more courier service orders. For example, the facility in various embodiments obtains a number, percentage, or other statistical measure corresponding to courier service orders requested having a selected preliminary requirement. The facility then obtains a statistical measure corresponding to courier agents meeting the selected preliminary requirement. The facility then compares the statistical measure of the selected preliminary requirement to the statistical measure of the courier service agents to determine whether a greater number of courier agents meeting the preliminary requirement is demanded. In some embodiments, a greater number of courier agents is demanded when a proportion of courier service orders having the selected preliminary requirement is greater than a proportion of courier agents meeting the preliminary requirement. In various embodiments, any suitable statistical measure and corresponding threshold for comparison is used. If a greater number is demanded, the facility in some embodiments causes the preliminary requirement to be displayed in incomplete requirements 504 for one or more courier agents not already meeting the preliminary requirement.

In some embodiments, the facility displays information associated with an incomplete requirement (not shown), such as a number of active but incomplete courier service orders that the courier agent would be qualified to perform upon completion of the incomplete requirement. In some embodiments, the facility displays an indication of remuneration for performing one or more courier service orders having the incomplete requirement as a preliminary requirement. In some embodiments the facility displays an average remuneration per order, per hour, etc., for courier service orders having the incomplete requirement as a preliminary requirement. This allows the courier agent to choose incomplete requirements to complete according to their remuneration.

In some embodiments, the facility receives uploaded preliminary requirement evidence. For example, incomplete requirement 504a is met in some embodiments when the facility receives a certificate uploaded using upload portal 506a. In various embodiments, the facility verifies that the uploaded certificate is authentic, relevant to the preliminary requirement, current, legible, etc. Verification is performed in some embodiments manually by a human. In some embodiments, verification is performed automatically using feature extraction techniques and comparing the uploaded certificate to exemplar certificates for the same preliminary requirement or expected features of the certificate. The comparison is, in some embodiments where the certificate is an image, performed using known image processing techniques such as convolutional neural networks, edge detection algorithms, autoencoders, etc. In some embodiments where the certificate includes text, feature extraction is performed by parsing the certificate according to known parsing techniques. In some embodiments, a combination of automatic and manual verification is performed.

In some embodiments, a preliminary requirement in incomplete requirements 504 is met when the facility receives input reflecting enrollment in and completion of a course. For example, incomplete requirement 504a is met in some embodiments when the facility receives input from a courier agent enrolling in a course using enrollment portal 508a and subsequent input completing the course. In some embodiments, an incomplete requirement is added to incomplete requirements 504 according to renewal frequency 320 in FIG. 3.

FIG. 5B illustrates an interface 500b displaying a course to be completed to meet incomplete requirement 504a in response to the facility receiving a selection of enrollment portal 508a. In some embodiments, the facility supports completion of the course through interface 500b. In some embodiments, the facility directs the courier agent to a third-party web page to complete the course. In various embodiments the course is free or paid for by a courier agent, a courier agent contracting entity, or a courier service order customer.

FIG. 5C illustrates an interface 500c reflecting completion of the course displayed in interface 500b. In response to completion of a course or uploading a document, the facility displays completed requirement 510a in completed requirements 510 instead of incomplete requirement 504a in incomplete requirements 504 shown in interface 500a.

Returning to FIG. 2, process 200 proceeds from block 204 to block 206. At block 206, the facility causes a visual interface to be presented that corresponds to a contracting entity of the courier agent and contains an indication of each courier agent of the contracting entity that meets the one or more preliminary requirements.

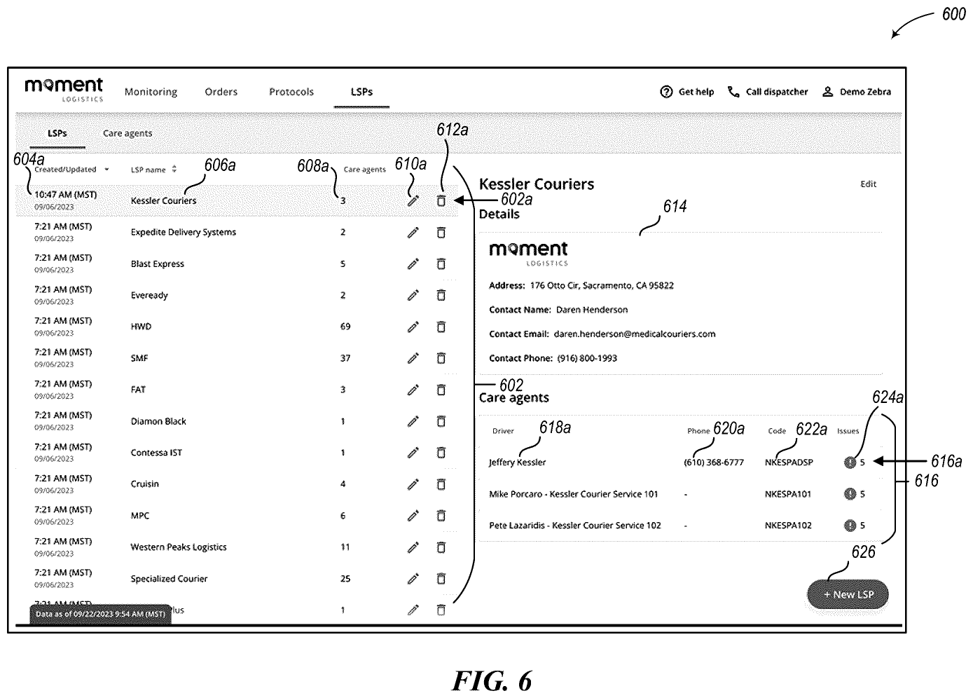

FIG. 6 is a display diagram illustrating an interface 600 used by the facility in some embodiments to display a plurality of courier agent contracting entities. Interface 600 further supports viewing courier agents at the courier agent level upon selection of a specific courier agent contracting entity. In various embodiments, the facility causes interface 600 to be displayed using ordering devices 110, reviewer devices 130, or server 150.

Interface 600 includes courier agent contracting entities 602. Courier agent contracting entity 602a in courier agent contracting entities 602 includes modification time 604a, courier agent contracting entity name 606a, capacity summary 608a, edit button 610a, and discard button 612a. In some embodiments, capacity summary 608a reflects a total number of courier agents contracted by the courier agent contracting entity. In some embodiments, capacity summary 608a reflects a total number of courier agents meeting one or more selected preliminary requirements (not shown).

In the example shown in FIG. 6, the facility receives input selecting courier agent contracting entity 602a. Accordingly, the facility displays information regarding courier agent contracting entity 602. The displayed information includes contact information 614 and courier agents 616. Courier agents 616 corresponds to courier agents contracted by courier agent contracting entity 602a. Courier agent 616a represents a specific courier agent and includes name 618a, phone number 620a, courier agent code 622a, and compliance summary 624a. Add courier agent contracting entity button 626 enables the facility to add a courier agent contracting entity to courier agent contracting entities 602.

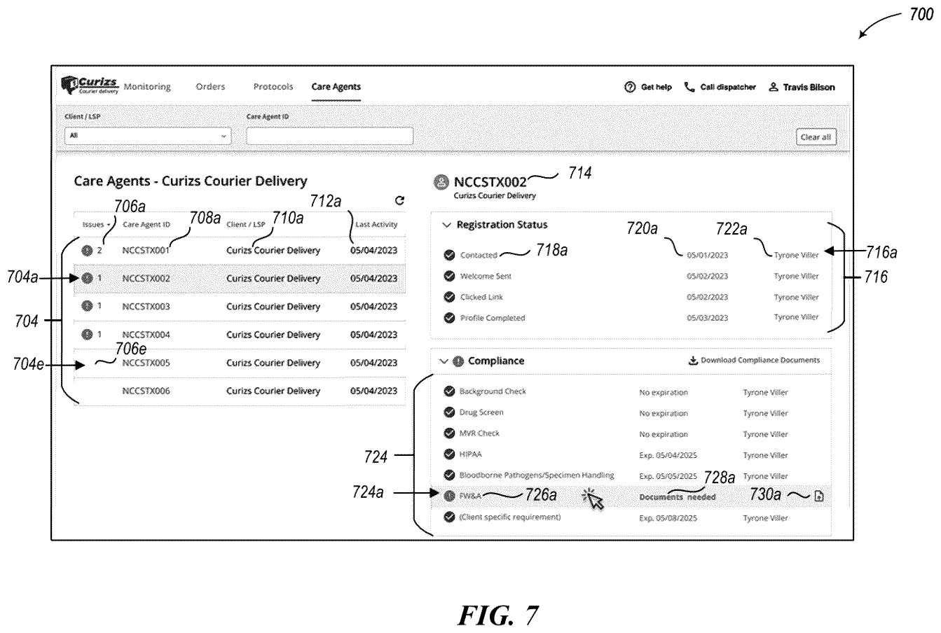

FIG. 7 is a display diagram illustrating an interface 700 used by the facility in some embodiments to manage preliminary requirements for a courier agent associated with a courier agent contracting entity. In various embodiments, the facility causes interface 800 to be displayed using ordering devices 110, reviewer devices 130, or server 150.

Interface 700 includes courier agent contracting entity 702. Courier agents 704 represent courier agents contracted by courier agent contracting entity 702. Courier agent 704a in courier agents 704 includes compliance summary 706a, agent ID 708a, contracting entity 710a, and last activity 712a. Compliance summary 706a indicates the number of compliance items with non-compliant status for the corresponding courier agent. Here, compliance summary 706a indicates that there is one compliance item with non-compliant status for courier agent 704a. In contrast, the absence of compliance summary 706e with respect to courier agent 704e indicates that there are no compliance items with non-compliant status for courier agent 704e.

In the example shown in FIG. 7, courier agent 704a is selected. Accordingly, interface 700 displays information regarding courier agent 704a, including agent ID 714, registration statuses 716, and preliminary requirement statuses 724. Registration status 716a in registration statuses 716 includes status indicator 718a, registration date 720a, and compliance officer 722a.

In various embodiments, compliance officer 722a indicates a compliance officer that verifies compliance evidence to generate preliminary requirement statuses 724. For example, when a courier agent uploads a document to verify a preliminary requirement such as a background check, compliance officer 722a may authenticate the document, verify that the document is responsive to the preliminary requirement, etc.

Preliminary requirement statuses 724 correspond to preliminary requirements to be met by the courier agent to be eligible to perform various protocols having preliminary requirements. Referring to FIG. 4, according to some embodiments, preliminary requirement statuses 724 correspond to preliminary requirements 434 enabled in a protocol using interface 400. In various embodiments, preliminary requirement statuses 724 correspond to a union of preliminary requirements for a plurality of protocols. For example, preliminary requirement statuses 724 in various embodiments includes preliminary requirements for a plurality of protocols performed on behalf of courier agent contracting entity 702.

Preliminary requirement status 724a includes preliminary requirement indicator 726a, which indicates whether the preliminary requirement is met. Status description 728a describes a status of the preliminary requirement and upload portal 730a supports uploading documentation related to the preliminary requirement.

Returning to FIG. 2, after block 206, process 200 proceeds to block 208. At block 208, the facility causes an indication of compliance to be displayed in response to receiving preliminary compliance evidence. In some embodiments, the indication of compliance is compliance summary 706a in FIG. 7. In some embodiments, the facility receives preliminary compliance evidence using upload portal 730a in FIG. 7. In some embodiments, the facility receives preliminary compliance evidence using upload portal 506a in FIG. 5. After block 208, process 200 proceeds to block 210.

At block 210 the facility receives a selection of a courier agent. In various embodiments, the selection is made using ordering devices 110, servers 150, or reviewer devices 130. In some embodiments, the facility receives a selection of the courier agent from a courier service order customer. Referring to FIG. 6, for example, the customer views interface 600 and selects courier agent contracting entity 602a. Then, the customer selects one of courier agents 616, such as courier agent 616a, to perform a courier service order. In various embodiments, the facility receives selection of the courier agent using embodiments of interface 700 in FIG. 7. In some embodiments, a dispatcher selects the courier agent to perform the courier service order. In some embodiments, a courier agent contracting entity selects the courier agent to perform the courier service order. After block 210, process 200 proceeds to block 212.

At block 212, the facility causes the sequence of courier steps to be sequentially displayed on an interface displayed on the device of the courier agent. In some embodiments, a current step in the sequence of courier steps is displayed. In some embodiments, a plurality of steps including the current step is displayed. In some embodiments, the facility advances to a next step in the sequence of steps in response to receiving execution compliance evidence or other input from the courier agent. In some embodiments, the facility automatically advances to the next step in the sequence of steps based on comparing a GPS position of the device of the courier to a GPS position associated with the current step. After block 212, process 200 proceeds to block 214.

At block 214, the facility receives execution compliance evidence. In some embodiments, execution compliance evidence is collected in accordance with a setting of compliance evidence selector 426 in FIG. 4 made with respect to a particular step in a protocol. In an example embodiment, the courier agent is required to collect execution compliance evidence including scanning a barcode. In some embodiments, the execution compliance evidence is collected in accordance with a protocol. The courier agent is in some embodiments permitted to collect execution compliance evidence at any of a plurality of steps in a protocol. For example, a protocol in some embodiments specifies that a courier agent is required to take a temperature of an object at least once at any point during execution of the protocol. After block 214, process 200 proceeds to block 216.

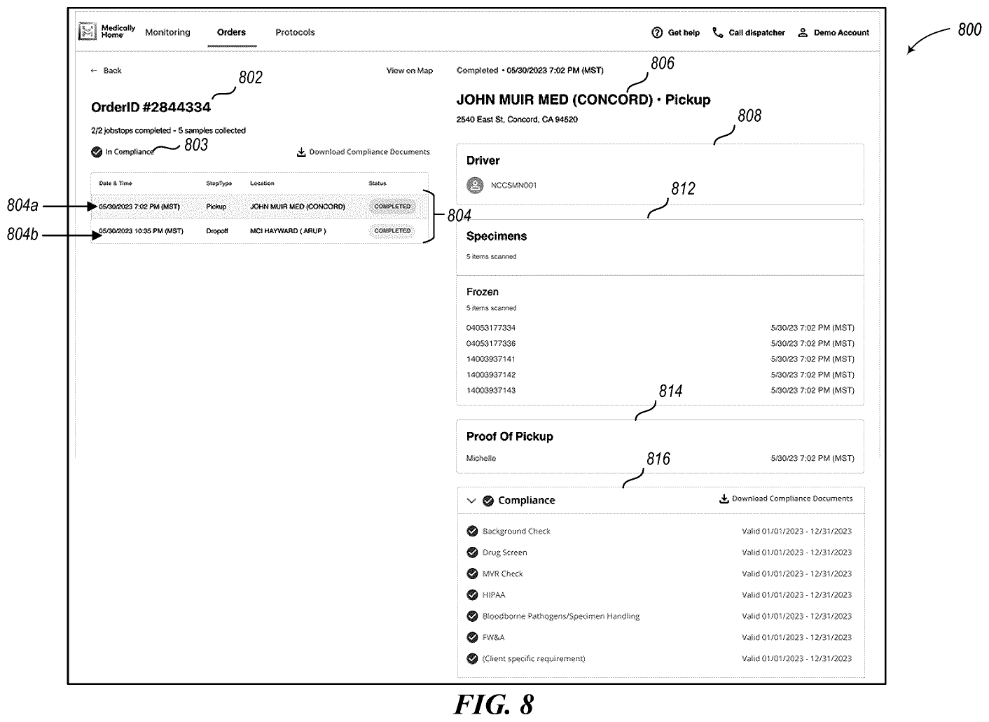

At block 216, the facility creates an indication of compliance reflecting the preliminary compliance evidence and the execution compliance evidence. In some embodiments, the indication of compliance is similar to indication of compliance 803 in FIG. 8. After block 216, process 200 continues to block 218.

At block 218, the facility causes the indication of compliance to be accessible to the courier order customer. In some embodiments, the indication of compliance is made accessible through a user interface such as interface 800 described herein. In various embodiments, the indication of compliance is made accessible to the customer using email, SMS, a messaging application, a social media application, etc. After block 218, process 200 ends at an end block.

FIG. 8 is a display diagram illustrating an interface 800 used by the facility in some embodiments to display hierarchical compliance information for a courier service order. In various embodiments, the facility causes interface 800 to be displayed using ordering devices 110, agent mobile devices 120, reviewer devices 130, or server 150.

Order 802 is an indication of a courier service order for which the facility is to display information. In various embodiments, the courier service order corresponding to interface 800 has not yet been assigned, is in progress, or has been completed. According to some embodiments, interface 800 updates in real time as the facility receives updates to the courier service order status. In the example shown in FIG. 8, the courier service order has been completed and is in full compliance, as demonstrated by indication of compliance 803.

Indication of compliance 803 reflects a compliance of the courier service order. Here, indication of compliance 803 reflects that the order complies with all procedures 804, as well as all sub-requirements of procedures 804. In various embodiments, indication of compliance 803 reflects compliance with all procedures 804 including pickup procedure 804a and dropoff procedure 804b. Here, pickup procedure 804a is selected. Accordingly, the facility causes interface 800 to display information corresponding to pickup procedure 804a.

A procedure such as pickup procedure 804a in various embodiments includes preliminary requirements, a courier service step requiring compliance evidence, or both. In the example shown in FIG. 8, indication of compliance 803 reflects full compliance with pickup procedure 804a, which includes preliminary requirements 816 and various courier service steps requiring compliance evidence including scanning five specimens in specimens 812 and proof of pickup 814. Interface 800 in various embodiments includes procedure name 806 and courier agent identifier 808.

Preliminary requirements 816 reflect the preliminary requirements to complete the order. In some embodiments, preliminary requirements 816 correspond to preliminary requirements 434 enabled for a protocol of the order using interface 400 in FIG. 4.

In the example shown in FIG. 8, indication of compliance 803 also reflects full compliance with dropoff procedure 804b. Similar to pickup procedure 804a, dropoff procedure 804b in some embodiments includes one or more preliminary requirements, one or more courier service steps requiring compliance evidence, or both. In some embodiments, two procedures such as pickup procedure 804a and dropoff procedure 804b include different preliminary requirements from each other, different courier service steps requiring compliance evidence, or both. In some embodiments, the preliminary requirement of one procedure in a courier service order is automatically added to all procedures in the courier service order such that one courier service agent may perform all procedures in a courier service order. In some embodiments, procedures in a courier service order include different sets of preliminary requirements such that different courier agents meeting different preliminary requirements perform different procedures in the courier service order. For example, pickup procedure 804a in an example embodiment includes a preliminary requirement of accessing a location requiring a security clearance. But dropoff procedure 804b may not have this preliminary requirement. In some embodiments, the preliminary requirement of accessing a location requiring a security clearance may be added to all procedures for the courier service order. In some embodiments, the preliminary requirement is only added to the specific procedure having the requirement, in this example, pickup procedure 804a. In this way, individual procedures in a courier service order may be performed by different courier agents meeting different preliminary requirements.

By reflecting compliance with all procedures, and all sub-requirements of all procedures, indication of compliance 803 supports rapidly auditing a potentially large number of requirements in a courier service order. In some embodiments, the facility causes indication of compliance 803 to be displayed in an interface including a plurality of indications of compliance corresponding to a plurality of courier service orders. In some embodiments, the interface displaying the indication of compliance corresponds to a courier agent contracting entity such as interface 700 in FIG. 7. In some embodiments, the interface corresponds to a customer. In some embodiments, the facility displays an indication of compliance for a courier service contracting entity or a courier service order customer, reflecting compliance with all requirements of a selection of tracked courier service orders. For example, the facility in some embodiments causes an indication of compliance reflecting compliance with all orders made by a courier service order customer to be displayed in an interface accessible to the courier service order customer.

In various embodiments, indication of compliance 803 represents that an order is in compliance even when one or more procedures are incomplete. For example, when interface 800 is viewed before dropoff procedure 804b has been completed, indication of compliance 803 in some embodiments reflects that the order is in full compliance, despite being incomplete. In some embodiments, a behavior of indication of compliance 803 is selectable using a user interface. For example, a courier service order customer selects that indication of compliance 803 only indicates non-compliance when the courier service order customer is to complete an additional step to enable completion of the courier service order.

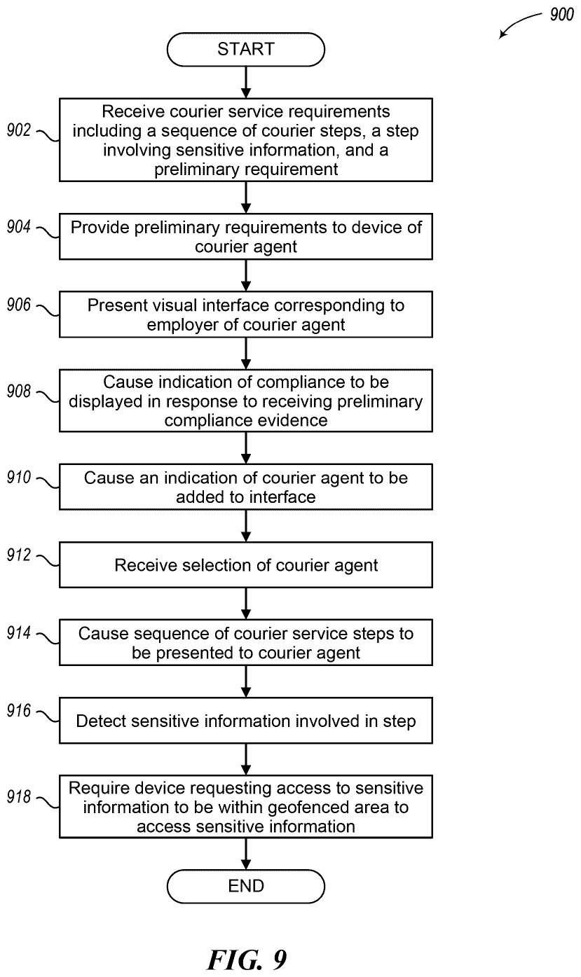

FIG. 9 is a flow diagram showing a process 900 used by the facility in some embodiments to manage compliance with courier service requirements by a device of a courier agent. Courier service orders often involve sensitive information. Courier service orders may require knowledge of a name, home address, health details, signature, access code, etc. While access to sensitive information is in some embodiments necessary to complete a courier service order, a courier agent performing the courier service order typically only needs access to the sensitive information for a selected step. Process 900 supports limiting access to sensitive information for a courier service order.

Process 900 begins, after a start block, at block 902 where the facility receives courier service requirements including a sequence of courier steps, sensitive information involved in the courier service order, and a preliminary requirement. In some embodiments, a courier service order customer specifies one or more of the sequence of courier steps, the step requiring sensitive information, or the preliminary requirement. In an example embodiment, the facility receives specification that a signature acquired by the courier agent when an object of the courier service order is delivered is sensitive information. In an example embodiment, the facility receives specification that an address provided for use in the courier service order is sensitive information.

The sensitive information is in some embodiments execution evidence collected by the courier agent. For example, in various embodiments the sensitive information is a photograph including personal information such as a person's name, address, an indication of the object, etc., or the sensitive information is a signature of a person receiving the courier service order.

In some embodiments, the sensitive information includes information displayed in one or more steps in the sequence of steps displayed to the courier agent performing the courier service order. In some embodiments, a step in the sequence of courier service steps includes a name, address, health information, etc., associated with the courier service order. The sensitive information is in some embodiments designated by the courier service order customer.

In various embodiments, the facility automatically determines sensitive information in addition to or instead of receiving a specification of sensitive information. The facility in some embodiments determines that information associated with a certain kind of courier service order, such as a medical courier order, is sensitive. In some embodiments, the facility determines that all information associated with a courier order is sensitive. After block 902, process 900 continues to block 904.

At block 904, the facility provides preliminary requirements to a device of a courier agent. In some embodiments, block 904 employs methods of block 204 to provide the preliminary requirements to the device of the courier agent. After block 904, process 900 continues to block 906.

Returning to FIG. 9, at block 906, the facility presents a visual interface corresponding to a contracting entity of the courier agent. In some embodiments, the visual interface is similar to interface 600 in FIG. 6. After block 906, process 900 continues to block 908.

At block 908, the facility causes an indication of compliance to be displayed in response to receiving preliminary compliance evidence. In some embodiments, the indication of compliance is compliance summary 624a in FIG. 6. After block 908, process 900 continues to block 910.

At block 910, the facility causes an indication of a courier agent to be added to the interface. In some embodiments, the indication of the courier agent is courier agent 616a in FIG. 6. After block 910, process 900 continues to block 912.

At block 912, the facility receives a selection of a courier agent. In various embodiments, block 912 employs embodiments of block 210 in FIG. 2 to receive selection of a courier agent. After block 912, process 900 continues to block 914.

At block 914, the facility causes the sequence of courier service steps to be presented to the courier agent. In some embodiments, block 914 employs methods of block 212 in FIG. 2 to cause the sequence of courier steps to be presented to the courier agent. After block 914, process 900 continues to block 916.

At block 916, the facility detects sensitive information involved in a step. In some embodiments, the facility detects selected execution evidence as sensitive information. In an example embodiment, the facility receives specification that a photograph to be taken by the courier agent in completing a step is sensitive information. The facility then, in some embodiments, designates information received in a corresponding input field displayed during performance of the step as sensitive.

In some embodiments, the facility detects sensitive information displayed in one or more steps in the sequence of steps displayed to the courier agent performing the courier service order. In an example embodiment, the courier agent begins performance of a courier service order, wherein an address is specified as sensitive information. The facility detects the sensitive information when the courier agent views the address. In some embodiments, the facility detects the sensitive information before the courier agent views the sensitive information. After block 916, process 900 continues to block 918.

At block 918, the facility requires a device requesting access to sensitive evidence to be within a geofenced area to access the sensitive evidence. As discussed herein, a courier agent completing a courier service order typically requires sensitive information for selected steps in the sequence of steps performed to complete a courier service order. When sensitive information is detected in connection with a step, access to the sensitive information is limited based on a geofenced area around the step's location. For example, when a courier agent is picking up medication from a pharmacy, the address to deliver the medication to is in some embodiments sensitive information and is not displayed until the courier agent requires it to deliver the medication.

In various embodiments, the sensitive information, a component of the sensitive information, or a substitute for the sensitive information is only displayed after the courier agent has been directed to a geofenced area containing the address. A geofence is a virtual perimeter corresponding to a geographic area. In some embodiments, the geofenced area is a circular area defined by a distance from the dropoff address. For example, the geofenced area is in various embodiments an area within one mile, one kilometer, 50 meters, etc., of the dropoff address. The facility in some embodiments receives manual configuration of the geofenced area using an interface. In some embodiments, the facility automatically determines a geofenced area for sensitive information. For example, the facility sets the radius of the geofenced area to a default distance from a location of a step involving the sensitive information, such as one mile. In various embodiments, the geofenced area is based on a sensitivity score computed for the sensitive information. In computing the sensitivity score, the facility in various embodiments considers variables such as a relevance of the information to completion of a courier service order, a sensitivity of the information, a qualification of the courier agent, etc.

In some embodiments, when the courier agent enters the geofenced area the facility causes the sensitive information to be accessible to the courier agent. In some embodiments, when the courier agent leaves the geofenced area, the facility causes the sensitive information to be inaccessible to the courier agent. After block 918, process 900 ends at an end block.

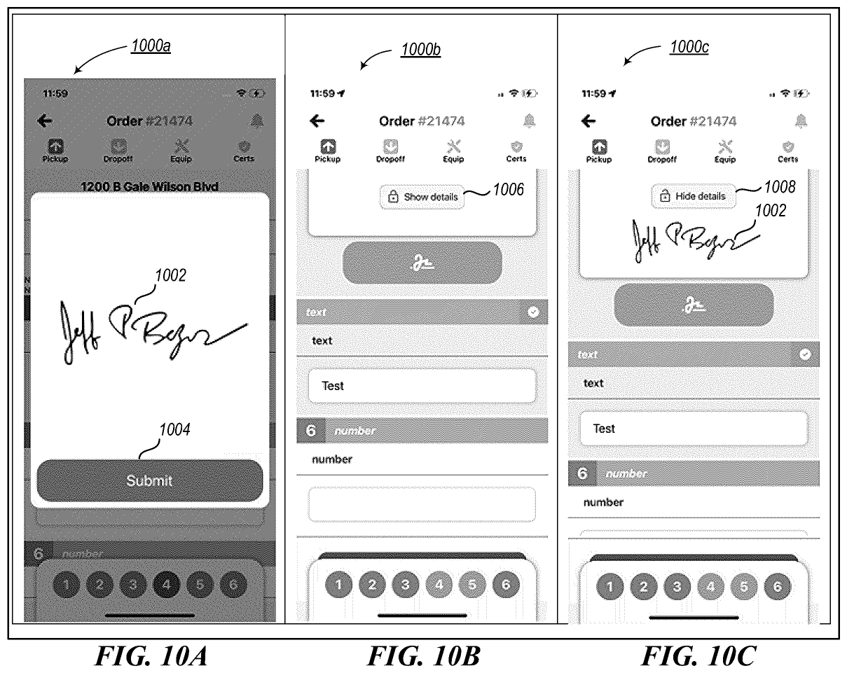

FIGS. 10A, 10B, and 10C are display diagrams illustrating various interfaces used by the facility in various embodiments to enable permission-restricted access to sensitive information relating to a courier service order.

FIG. 10A illustrates an example interface 1000a for collecting sensitive information. As discussed herein, execution compliance evidence is in some embodiments required to complete a courier service order. Sensitive information 1002 is collected and submitted using submit button 1004.

FIG. 10B illustrates an example interface 1000b hiding sensitive information 1002. Receiving a selection of show details button 1006 logs the attempt to access sensitive information 1002 and causes the facility to display sensitive information 1002 if the display is authorized.

FIG. 10C illustrates an example interface 1000c wherein sensitive information 1002 is displayed in response to a selection of show details button 1006 in FIG. 10B. In this example, show details button 1006 is replaced with hide details button 1008, which supports hiding sensitive information 1002 as shown in FIG. 10B. In some embodiments, the facility automatically hides sensitive information 1002 after a predetermined time such as five seconds, ten seconds, a minute, etc. In some embodiments, the facility automatically hides sensitive information 1002 when the facility detects a device displaying the sensitive information leaves a geofenced area associated with the sensitive information as described with respect to FIG. 9.

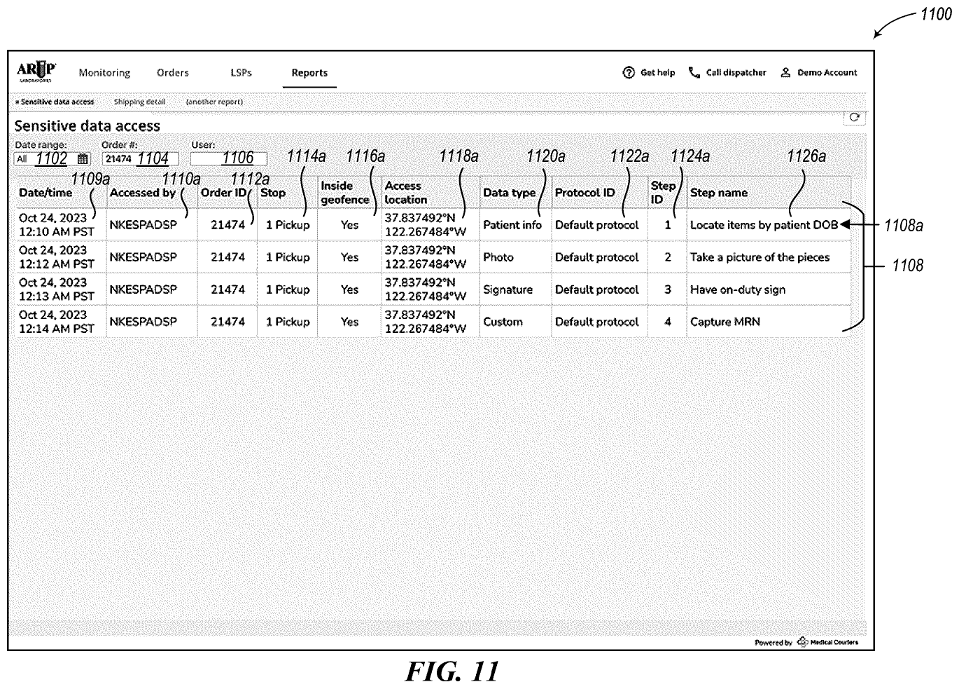

FIG. 11 is a display diagram illustrating an interface 1100 used by the facility in some embodiments to display a sensitive data access report for a courier service order. As described herein, in some embodiments the facility logs attempts to access sensitive information. In various embodiments shown in FIG. 11, the facility displays sensitive data access information for a data range received from date range selector 1102, for an order received from order field 1104, for a user received from user field 1106, or a combination thereof. Access logs 1108 include access log 1108a. Access log 1108a includes access time 1109a, user log 1110a, order log 1112a, stop log 1114a, geofence log 1116a, access location log 1118a, data type log 1120a, protocol ID log 1122a, step ID log 1124a, and step name log 1126a. Interface 1100 allows a courier service order customer, contracting entity, or reviewer to audit access to sensitive information by courier service agents or others.

In some embodiments, the facility allows the courier agent to access the sensitive information from outside of the geofence after displaying a warning that the access is being recorded. For example, the courier agent may have forgotten an item at an address, where the address constitutes sensitive information. In this example, the facility allows the courier agent to access the sensitive address but records information about the access and causes the information to be displayed in interface 1100, which is made accessible in various embodiments to server 150, reviewer devices 130, or ordering devices 110.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method for managing compliance with courier service requirements, the method comprising:
receiving courier service requirements defining for a courier service order one or more preliminary requirements and a sequence of courier service steps;
providing the one or more preliminary requirements to a device of a courier agent;
causing a visual interface to be presented that corresponds to a contracting entity of the courier agent, and contains an indication of each courier agent of the contracting entity that meets the one or more preliminary requirements;
in response to receiving preliminary compliance evidence for a preliminary requirement, causing an indication of compliance to be added to the displayed interface;
in response to receiving a selection by a customer of the courier agent using the interface, causing the sequence of courier service steps to be sequentially displayed using an interface displayed on the device of the courier agent;
in response to receiving execution compliance evidence for a step in the sequence of courier service steps, creating an indication of compliance that reflects the preliminary compliance evidence and the execution compliance evidence; and
causing the indication of compliance to be accessible to the customer.

2. The method of claim 1, further comprising:
causing an indication of compliance with a preliminary requirement to be added to the displayed interface.

3. The method of claim 1, further comprising:
causing the received preliminary compliance evidence to be accessible to the customer using the displayed interface.

4. The method of claim 1, further comprising:
causing a plurality of indications of interfaces corresponding to a plurality of contracting entities to be added to the displayed interface.

5. The method of claim 1, further comprising:
causing a plurality of indications of interfaces corresponding to a plurality of courier agent contracting entities to be added to the displayed interface; and
causing a summarization of a capacity of each of the courier agent contracting entities to be added to the displayed interface.

6. The method of claim 1, wherein the preliminary compliance evidence includes completion of a course, and the course is provided to the device of the courier agent.

7. The method of claim 1, further comprising:
in response to receiving a selection of the indication of compliance, displaying the execution compliance evidence and the preliminary compliance evidence.

8. A system for managing compliance with courier service requirements, the system comprising:
one or more memories configured to collectively store computer instructions; and
one or more processors configured to collectively execute the stored computer instructions to:
receive courier service requirements specifying for a courier service order:
a sequence of courier service steps,
sensitive information involved, and
a preliminary requirement; and
in response to receiving preliminary compliance evidence for the preliminary requirement, cause an indication of a courier agent to be added to an interface;
in response to receiving a selection of the courier agent using the interface, cause the sequence of courier service steps to be sequentially displayed on a device of the courier agent; and
in response to detecting the sensitive information, require, to access the sensitive information, the requesting device to be within a geofenced area including a location of the step for which the sensitive evidence is involved.

9. The system of claim 8, wherein the one or more processors are further configured to:
in response to detecting that the device of the courier agent is not within the geofenced area, hide a display of the sensitive evidence on the courier agent device.

10. The system of claim 8, wherein the one or more processors are further configured to:
in response to receiving a request to access the sensitive evidence, log the request in a record corresponding to the courier service order.

11. The system of claim 8, wherein the preliminary compliance evidence includes completion of a course provided to the device of the courier agent.

12. The system of claim 8, wherein the one or more processors are further configured to:
notify a party when a request to access sensitive evidence is received.

13. One or more memories collectively storing instructions that, when executed by one or more processors in a computing system, cause the one or more processors to perform a method, the method comprising:
receiving courier service requirements defining for a courier service order a preliminary requirement and a sequence of courier service steps;
providing the preliminary requirement to a device of a courier agent;
in response to receiving preliminary compliance evidence for the preliminary requirement, causing an indication of compliance to be added to a displayed interface;
in response to receiving, by the interface, a selection by a customer of the courier agent, causing the sequence of courier service steps to be sequentially displayed on an interface displayed on the device of the courier agent;
in response to receiving execution compliance evidence for each step in the sequence of courier service steps, creating an indication of compliance that reflects the preliminary compliance evidence and the execution compliance evidence; and
causing the indication of compliance to be accessible to the customer.

14. The one or more memories of claim 13, the method further comprising:
causing an indication of compliance with a preliminary requirement to be added to the displayed interface.

15. The one or more memories of claim 13, the method further comprising:
causing the received preliminary compliance evidence to be added to the displayed interface.

16. The one or more memories of claim 13, the method further comprising:
causing a plurality of indications of interfaces corresponding to a plurality of courier service contracting entities to be added to the displayed interface.

17. The one or more memories of claim 13, the method further comprising:
causing a plurality of indications of interfaces corresponding to a plurality of courier service orders to be added to the displayed interface; and
causing a compliance status summary of each of the plurality of orders to be added to the displayed interface.

18. The one or more memories of claim 13, wherein the preliminary compliance evidence includes completion of a course provided to the device of the courier agent.

19. The one or more memories of claim 13, the method further comprising:
in response to receiving a selection of the indication of compliance, displaying the execution compliance evidence and the preliminary compliance evidence.

20. The one or more memories of claim 13, wherein the received execution compliance evidence includes an environmental characteristic measured by the device of the courier agent.

21. The one or more memories of claim 13, the method further comprising:
causing a plurality of indications of compliance corresponding to a plurality of courier service orders to be added to the displayed interface.
